(19) United States
(12) Patent Application Publication
(10) Pub. No.: US 2010/0290428 A1
(43) Pub. Date: Nov. 18, 2010

(54) MOBILE COMMUNICATION SYSTEM, BASE STATION DEVICE, AND HANDOVER METHOD

(75) Inventor: Hiroki Fujita, Yokohama-Shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/680,533

(22) PCT Filed: Sep. 10, 2008
(86) PCT No.: PCT/JP2008/066306

§ 371 Date: Jul. 20, 2010

(30) Foreign Application Priority Data
Sep. 26, 2007 (JP) 2007-249492

(51) Int. Cl. H04W 36/00

(52) U.S. Cl. 370/331

(57) ABSTRACT

A communication path between base stations is switched so as to prevent data transmitted from a mobile station undergoing handover from being lost. A base station (12) which is a handover destination includes an RTP communication control unit (34) for receiving an RTP packet corresponding to a radio signal transmitted from a first mobile station from a base station which is a handover source and transferring the received RTP packet to another base station which performs a radio communication, with a second mobile station which makes a call connection with the first mobile station with a handover start of the first mobile station, a voice comparison unit (40) for determining the identity of voice information included in the received RTP packet and voice information included in a radio signal received from the first mobile station, and a transmit data switching unit (42) for switching the RTP packet transmitted by the RTP communication control unit (34) to the another base station from the RTP packet received from the handover source base station to the RTP packet corresponding to the radio signal received from the first mobile station at a timing when the identity of the voice information is confirmed.

### TECHNICAL FIELD

The present invention relates to a mobile communication system, a base station device, and a handover method, and more particularly to a handover technology in a mobile communication system including a plurality of base station devices connected to each other via a network.

### BACKGROUND OF ART

In recent years, in a mobile communication system such as a cellular phone or a personal handy-phone system (PHS), with an aim to improve a speech quality and reduce line costs, etc., a study has been made to switch a backbone between base stations from a line switching network to an Internet Protocol (IP) network. In a mobile communication system in which the base stations are connected to each other by an IP network, a communication path between the base stations is switched with handover of a mobile station.

FIG. 6 are diagrams for illustrating a procedure of handing over a mobile station 74-1 that makes a call connection with a mobile station 74-2 from a base station 72-1 to a base station 72-2 in a conventional mobile communication system 70 where a real-time transport protocol (RTP) being one of connectionless transport protocols is applied to a data communication between the base stations. As illustrated in FIG. 6, an RTP session 1 (switching source session) is established between the handover source base station 72-1 and the base station 72-3 that makes a radio connection with the mobile station 74-2 before the mobile station 74-1 starts handover, and communication data is transmitted and received by the aid of the RTP session 1 (refer to FIG. 6(a)).

In this example, when the mobile station 74-1 starts handover to the base station 72-2, the base station 72-3 releases the RTP session 1 established with respect to the handover source base station 72-1, and newly establishes an RTP session 2 (switching destination session) with respect to the handover destination base station 72-2 (refer to FIG. 6(b)).

Patent document 1 discloses a technology for avoiding a network failure in an IP network and the degradation of a communication quality inexpensively and simply. Further, Patent document 2 discloses a technology for performing an automatic and seamless vertical roaming between a wireless wide area network (WWAN) and a wireless local area network (WLAN) while maintaining voice or data communication.

### Patent Document 1: JP 2001-53794 A

### Patent Document 2: JP 2004-517574 A

### DISCLOSURE OF THE INVENTION

### Problems to be Solved by the Invention

However, in the above-mentioned conventional mobile communication system, because a switching of a communication path between base stations by handover is performed in asynchronization, data transmitted from a mobile station undergoing handover may be partially discarded in the base stations.

For example, in the mobile communication system 70 illustrated in FIG. 6, when an establishing timing of the RTP session 2 is earlier than the releasing timing of the RTP session 1, the base station 72-3 may continue to monitor the RTP session 1 that has already completed data transmission from the base station 72-1, and discard data of the RTP session 2 which is transmitted from the base station 72-2. On the contrary, when the establishing timing of the RTP session 2 is later than the releasing timing of the RTP session 1, the base station 72-3 may discard data stored in a jitter buffer of the RTP session 1 without transmitting the data to the mobile station 74-2.

The present invention has been made in view of the above-mentioned problem with the conventional art, and aims at providing a mobile communication system, a base station device, and a handover method, which switch a communication path between the base stations which are connected to each other via a network so as to prevent data transmitted from the mobile station device undergoing handover from being lost.

### Means for Solving the Problems

In order to solve the above-mentioned problem, the present invention provides a mobile communication system including a plurality of base station devices connected to each other via a network, in which a first mobile station device performs a handover from a first base station device to a second base station device, in which the first base station device includes: first data transmitting means for transmitting data corresponding to a radio signal received from the first mobile station device to another base station device that performs a radio communication with a second mobile station device which makes a call connection with the first mobile station device; and data transmission destination switching means for switching a transmission destination of the data transmitted by the first data transmitting means from the another base station device to the second base station device with a handover start of the first mobile station device, and in which the second base station device includes: data receiving means for receiving the data transmitted by the first data transmitting means; second data transmitting means for transferring the data received by the data receiving means to the another base station device; identity determining means for determining identity of information included in the data received by the data receiving means and information included in a radio signal received from the first mobile station device; and transmit data switching means for switching the data transmitted by the second data transmitting means from the data received by the data receiving means to data corresponding to the radio signal received from the first mobile station device at a timing when the identity of information is confirmed by the identity determining means.

According to the present invention, a communication path between the base station devices is switched at a timing when data transmitted from the handover source base station device to the another base station device conforms to data transmitted from the handover destination base station device to the another base station device. As a result, data transmitted from the mobile station device undergoing handover can be prevented from being lost.

Further, in an aspect of the present invention, data transmitted and received between the base station devices is a packet based on a connectionless transport protocol, and the transmit data switching means carries over at least a part of header information of a packet transmitted before the switching to a packet transmitted after the switching so as to maintain continuity of the packets transmitted by the second data transmitting means before and after the switching of the transmit data. According to this aspect, the transmission source of the packet to be transmitted to the another base station device switches from the handover source base station device to the handover destination base station device, without the another base station device performing the operation of switching the session in the packet transport layer. As a result, a processing load on the another base station device, which is caused by handover, can be reduced.

In this aspect, the connectionless transport protocol may be an RTP protocol, and the transmit data switching means may carry over a sequence number, a time stamp, and a synchronization source identifier included in a header of an RTP packet transmitted before the switching to an RTP packet transmitted after the switching so as to maintain continuity of the packets transmitted by the second data transmitting means before and after the switching of the transmit data. With the above-mentioned configuration, a new RTP session can be established between the another base station device and the handover source base station device at the same time when the RTP session established between the another base station device and the handover source base station device is released, without the another base station device performing the operation of switching the RTP session.

Further, the present invention provides a base station device that is connected to another base station device via a network, and with a start of handover made by a first mobile station device that performs a radio communication with the another base station device, starts a radio communication with the first mobile station device, the base station device including: data receiving means for receiving data corresponding to a radio signal transmitted from the first mobile station device from the another base station device with the start of the handover; data transmitting means for transferring the data received by the data receiving means to yet another base station device that performs a radio communication with a second mobile station device which makes a call connection with the first mobile station device; identity determining means for determining identity of information included in the data received by the data receiving means and information included in a radio signal received from the first mobile station device; and transmit data switching means for switching the data transmitted by the data transmitting means from the data received by the data receiving means to the data corresponding to the radio signal received from the first mobile station device at a timing when the identity of information is confirmed by the identity determining means.

Further, the present invention provides a handover method for performing a handover from a first base station device to a second base station device by a first mobile station device in a mobile communication system including a plurality of base station devices connected to each other via a network, the handover method including: a data transmission destination switching step of switching, by the first base station device, with a start of the handover made by the first mobile station device, a transmission destination of data corresponding to a radio signal received from the first mobile station device from another base station device that performs a radio communication with a second mobile station device which makes a call connection with the first mobile station device to the second base station device; a data receiving step of receiving, by the second base station device, the data transmitted from the first base station device after the data transmission destination switching step; a data transmitting step of transferring, by the second base station device, the data received in the data receiving step to the another base station device; an identity determining step of determining, by the second base station device, identity of information included in the data received in the data receiving step and information included in a radio signal received from the first mobile station device; and a step of switching, by the second base station device, the data transmitted in the data transmitting step from the data received in the data receiving step to the data corresponding to the radio signal received from the first mobile station device at a timing when the identity of information is confirmed in the identity determining means step.

### BRIEF DESCRIPTION OF THE DRAWINGS

FIG. 1 A diagram illustrating an entire configuration of a mobile communication system according to an embodiment of the present invention.

FIG. 2 A functional block diagram illustrating a base station according to the embodiment of the present invention.

FIG. 3 A diagram illustrating a structure of an RTP packet.

FIG. 4 Diagrams for illustrating a handover procedure according to the embodiment of the present invention.

FIG. 5 A flowchart illustrating an example of a process of switching an RTP session according to the embodiment of the present invention.

FIG. 6 Diagrams for illustrating a conventional handover procedure.

### BEST MODE FOR CARRYING OUT THE INVENTION

Hereinafter, an embodiment of the present invention is described in detail with reference to the drawings.

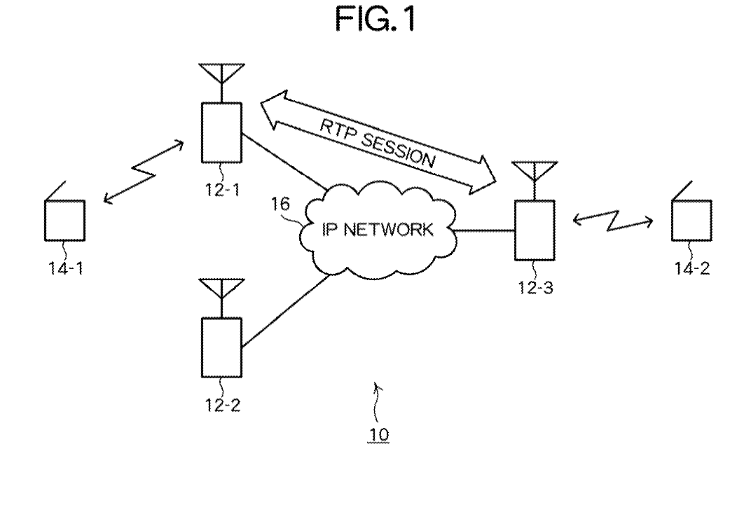

FIG. 1 is a diagram illustrating an entire configuration of a mobile communication system 10 according to the embodiment of the present invention. As illustrated in FIG. 1, a mobile communication system 10 includes a plurality of base stations 12 (in this example, only base stations 12-1 to 12-3 are illustrated), and a plurality of mobile stations 14 (in this example, only mobile stations 14-1 and 14-2 are illustrated). The base stations 12-1 to 12-3 are connected to each other via an IP network 16.

In the mobile communication system 10, when the mobile station 14-1 performs a voice communication with the mobile station 12-2, as illustrated in FIG. 1, an RTP session is established between the base station 12-1 that makes a radio connection with the mobile station 14-1 and the base station 12-3 that makes a radio communication with the mobile station 14-2, and voice data is transmitted or received through the RTP session. In this state, when the mobile station 14-1 performs handover from the base station 12-1 to the base station 12-2, voice data is transmitted or received by the aid of an RTP session which is newly established between the base station 12-2 and the base station 12-3. In particular, the mobile communication system 10 according to this embodiment has a function of establishing the RTP session (switching the RTP session) between the handover destination base station 12-2 and the base station 12-3 so as to prevent voice data transmitted from the mobile station 14-1 undergoing handover from being lost.

Hereinafter, a description is given in detail of configuration of the base station 12 in order to realize the above-mentioned function.

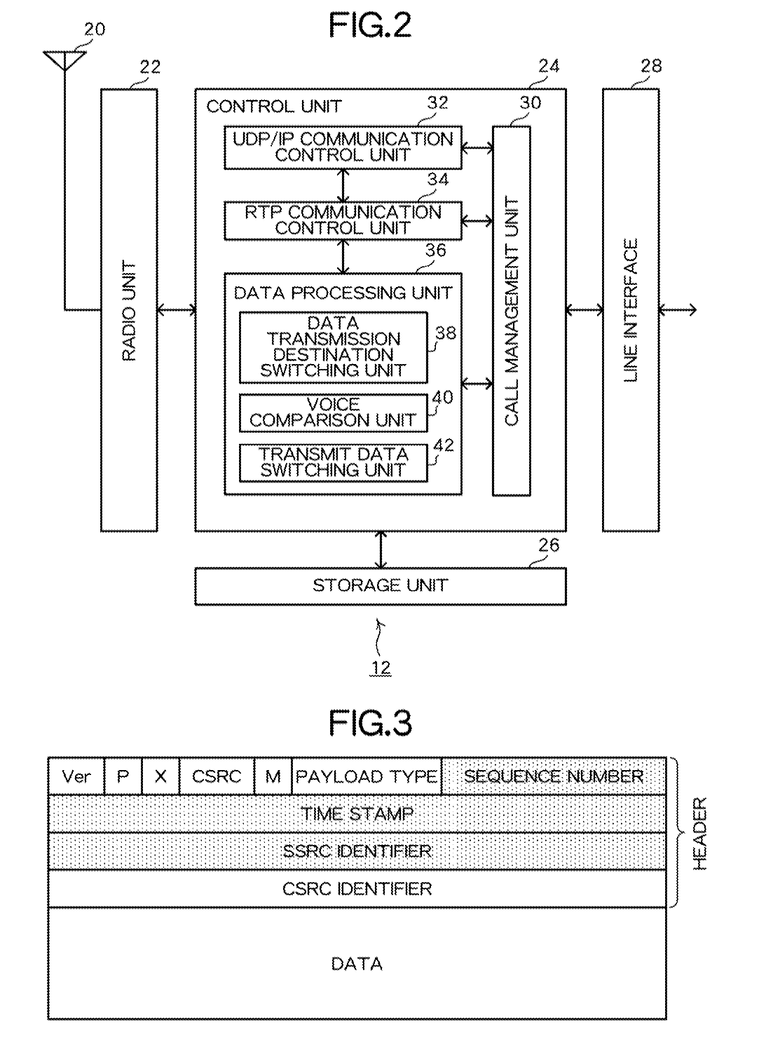

FIG. 2 is a functional block diagram of the base station 12. As illustrated in FIG. 2, the base station 12 includes an antenna 20, a radio unit 22, a control unit 24, a storage unit 26, and a line interface 28.

The antenna 20 radiates a radio signal supplied from the radio unit 22. Further, the antenna 20 receives a radio signal transmitted from the mobile station 14, and outputs the radio signal to the radio unit 22. It should be noted that the transmit and receive are switched in time division according to an instruction of the radio unit 22.

The radio unit 22 includes a power amplifier, a low noise amplifier, a bandpass filter, a mixer, a D/A converter, an A/D converter, a modulator circuit, a demodulator circuit, and so on. The radio unit 22 converts a radio signal received by the antenna 20 into a baseband signal, and outputs the baseband signal to the control unit 24 as radio receive data. Further, the radio unit 22 converts radio transmit data input from the control unit 24 into a radio signal, amplifies the converted radio signal up to a transmit power level, and supplies the radio signal to the antenna 20.

The control unit 24 is made up of, for example, a CPU and a program for controlling the operation of the CPU, and controls each of the units of the base station 12. Further, the control unit 24 functionally includes a call management unit 30, a UDP/IP communication control unit 32, an RTP communication control unit 34, and a data processing unit 36, and performs processing related to a data communication with the other base station 12. Those functions are realized by executing a program stored in the storage unit 26 through the CPU.

The storage unit 26 includes a memory element such as a RAM or a ROM, for example, and stores various programs for operating the control unit 24. Further, the storage unit 26 functions as a buffer for temporarily storing the radio receive data from the mobile station 14-1.

The line interface 28 connects the base station 12 and the IP network 16, outputs data (UDP/IP packet) input through the IP network 16 to the control unit 24, and outputs data (UDP/IP packet) input from the control unit 24 to the other base station 12 through the IP network 16.

Subsequently, the functional configuration of the control unit 24 is described in detail.

The call management unit 30 performs various processing related to a call management in response to a notification (for example, a call connection start notification or a handover start notification) from an exchange (or a higher-level device similar to the exchange) (not shown). For example, with an aim to establish the RTP session with call connection of the mobile station 14, or switch the RTP session with handover of the mobile station 14, the call management unit 30 controls the UDP/IP communication control unit 32, the RTP communication control unit 34, and the data processing unit 36.

Upon receiving, for example, a notification of “execute a handover from the base station 12-1 to the base station 12-2” from the mobile station 14-1 illustrated in FIG. 1, the exchange (or the higher-level device similar to the exchange) transmits, to the handover source base station 12-1, the handover start notification including information (IP address or the like) related to the handover destination base station 12-2. Further, the exchange transmits, to the handover destination base station 12-2, the handover start notification including information (IP address or the like) related to the handover source base station 12-1 and the base station 12-3.

The UDP/IP communication control unit 32 performs processing related to a data communication on the IP network 16 based on the UDP/IP protocol according to an instruction of the call management unit 30. Specifically, the UDP/IP communication control unit 32 establishes a UDP/IP session with respect to the other base station 12, or releases the established UDP/IP session. Then, the UDP/IP communication control unit 32 acquires an RTP packet from the UDP/IP packet input from the line interface 28, and outputs the acquired RTP packet to the RTP communication control unit 34. Further, the UDP/IP communication control unit 32 adds a given UDP header and a given IP header to the RTP packet input from the RTP communication control unit 34, and transmits the generated UDP/IP packet through the line interface 28.

The RTP communication control unit 34 performs processing related to the data communication on the IP network 16 based on the RTP protocol according to the instruction of the call management unit 30. Specifically, the RTP communication control unit 34 establishes an RTP UDP/IP session with respect to the other base station 12, or releases the established UDP/IP session. Then, the RTP communication control unit 34 acquires payload data from the RTP packet input from the UDP/IP communication control unit 32, outputs the payload data to the data processing unit 36 as wired receive data, and also stores a part of header information of the RTP packet (sequence number, time stamp, synchronization source (SSRC) identifier) therein (refer to a meshed part in FIG. 3). Further, the RTP communication control unit 34 adds a given RTP header to wired transmit data input from the data processing unit 36, and outputs the generated RTP packet to the UDP/IP communication control unit 32.

The data processing unit 36 includes a data transmission destination switching unit 38, a voice comparison unit 40, and a transmit data switching unit 42, and performs processing related to data transmitted or received with respect to the other base station 12 and data transmitted and received with respect to the mobile station 14 according to an instruction of the call management unit 30. Hereinafter, the data transmission destination switching unit 38 is described assuming that the subject base station 12 is the handover source base station 12-1 illustrated in FIG. 1. On the other hand, the voice comparison unit 40 and the transmit data switching unit 42 are described assuming that the subject base station 12 is the handover destination base station 12-2 illustrated in FIG. 1.

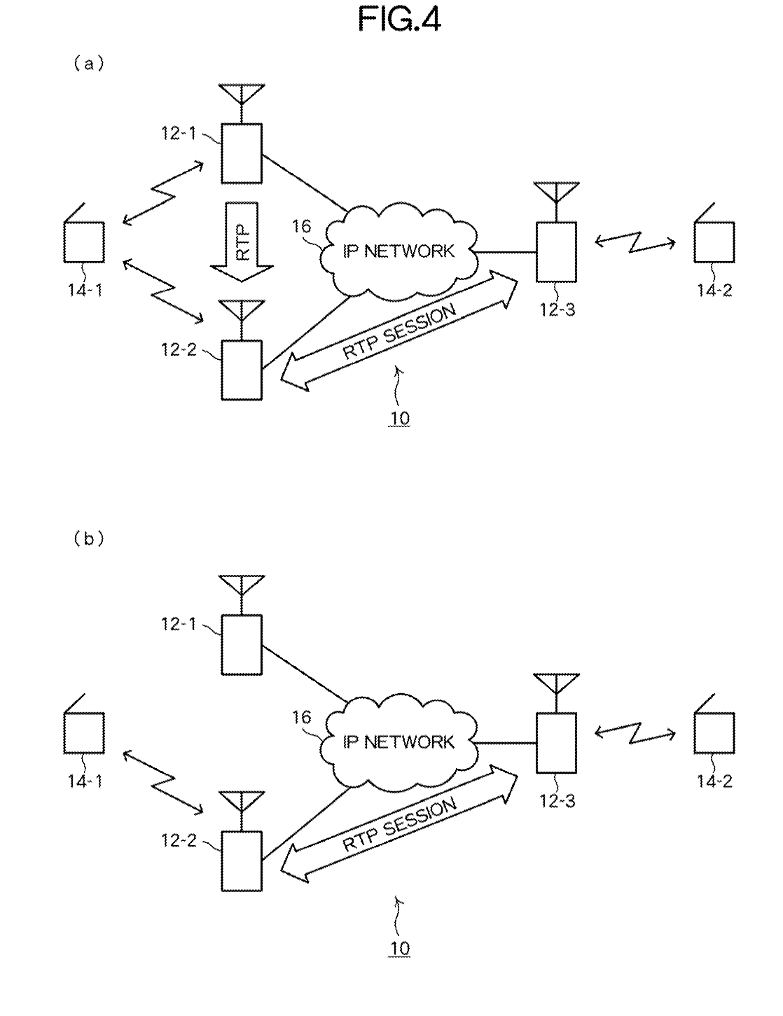

The data transmission destination switching unit 38 in the base station 12-1 switches the transmission destination of the radio receive data from the mobile station 14-1, which is input from the radio unit 22, from the base station 12-3 to the handover destination base station 12-2, with handover start of the mobile station 14-1. As a result, the RTP packet to be transmitted to the base station 12-3 from the handover source base station 12-1 is transmitted to the handover destination base station 12-2 by the RTP session established between the base station 12-1 and the base station 12-2, until the handover of the mobile station 14-1 is completed (refer to FIG. 4(a)). The base station 12-2 that has received the RTP packet transmitted from the base station 12-1 transfers the RTP packet transmitted from the handover source base station 12-1 to the base station 12-3 as it is, until the switching of the RTP session (releasing of the switching source session and establishment of the switching destination session) is performed (to be described later) (refer to FIG. 4(a)).

The voice comparison unit 40 in the base station 12-2 acquires the same voice data transmitted from the mobile station 14-1 through two communication paths of the RTP session established with respect to the handover source base station 12-1 and the radio transmission path. Then, the voice comparison unit 40 determines the identity of the voice information on the pieces of voice data acquired through the two communication paths, respectively, with an aim to specify a timing at which those two pieces of voice data are synchronous with each other in the handover destination base station 12-2.

That is, the voice comparison unit 40 compares the voice information included in the RTP packet received from the handover source base station 12-1 with the voice information included in the radio signal received from the mobile station 14-1, to thereby determine the identity thereof. For example, the voice comparison unit 40 may directly compare the voice data included in the RTP packet transmitted from the handover source base station 12-1 with the voice data included in the radio receive data from the mobile station 14-1, which has been input from the radio unit 22, or may obtain a correlation of a voice waveform (analog signal) corresponding to the voice data included in the above-mentioned RTP packet with a voice waveform (analog signal) corresponding to the voice data included in the above-mentioned radio receive data. Then, the voice comparison unit 40 instructs the transmit data switching unit 42 which is described later to switch the transmit data at the timing when the identity of the voice information is confirmed.

It should be noted that the voice comparison unit 40 may temporarily store the radio receive data input from the radio unit 22 in the storage unit 26 (buffer), and confirm whether or not the radio receive data identical (or high in correlation) with the payload data included in the RTP packet is stored in the buffer, to thereby determine the identity of the voice information. With this configuration, even if the identical voice data transmitted from the mobile station 14-1 reaches the base station 12-2 through a different communication path at a different timing, the voice comparison unit 40 can accurately specify the timing at which both pieces of voice data are synchronous with each other in the base station 12-2.

The transmit data switching unit 42 in the base station 12-2 switches the RTP packet, which is transmitted to the base station 12-3 by the RTP communication control unit 34, from the RTP packet received from the handover source base station 12-1 to the RIP packet including the radio receive data from the mobile station 14-1, which is input from the radio unit 22, at a timing when the identity of the voice information is confirmed by voice comparison unit 40. As a result, a new RTP session is established between the handover destination base station 12-2 and the base station 12-3 without lost of the voice data transmitted from the mobile station 14-1 undergoing handover (refer to FIG. 4(b)).

In particular, the transmit data switching unit 42 instructs the RTP communication control unit 34 to maintain the continuity of the RTP packets before and after the RTP communication control unit 34 switches the RTP packet that is transmitted to the base station 12-3. That is, the transmit data switching unit 42 instructs the RTP communication control unit 34 to carry over a part of header information of the RTP packet (in this example, called “pre-switching RTP packet”) transmitted by the RTP communication control unit 34 immediately before switching to the RTP packet (in this example, called “post-switching RTP packet”) transmitted immediately after switching.

Specifically, the RTP communication control unit 34 sets a value resulting from adding 1 to sequence number of the pre-switching RTP packet, as the sequence number of the post-switching RTP packet according as an instruction of the transmit data switching unit 42. Further, the RTP communication control unit 34 sets a value resulting from adding a reproduction period of the voice data included in the post-switching RTP packet to a time stamp of the pre-switching RTP packet, as a time stamp of the post-switching RTP packet. Further, the RTP communication control unit 34 sets the SSRC identifier of the pre-switching RTP packet as it is as the SSRC identifier of the post-switching RTP packet.

As a result, even if the RTP session switches with handover of the mobile station 14-1, in terms of the base station 12-3, the transmission source of the RTP packet does not change from the handover source base station 12-1, and the continuity of the sequence number and the time stamps of the RTP packet received by the base station 12-3 is maintained. As a result, the base station 12-3 is not required to perform the operation of switching the RTP session with handover of the mobile station 14-1, and the processing load is reduced. Specifically, the following processing to be performed with switching of the RTP session can be omitted: (1) processing of releasing the RTP session established with respect to the handover source base station 12-1; (2) processing of establishing the RTP session with respect to the handover destination base station 12-2; and (3) processing of recalculating a reproduction time of the RTP reproduction period.

Now, the operation of the base station 12 is described.

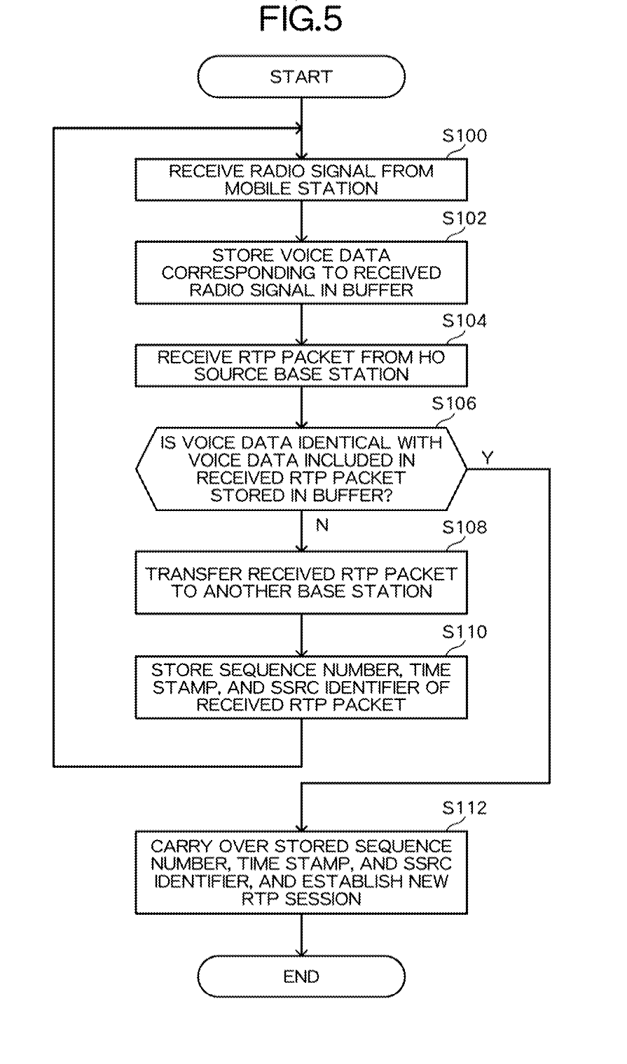

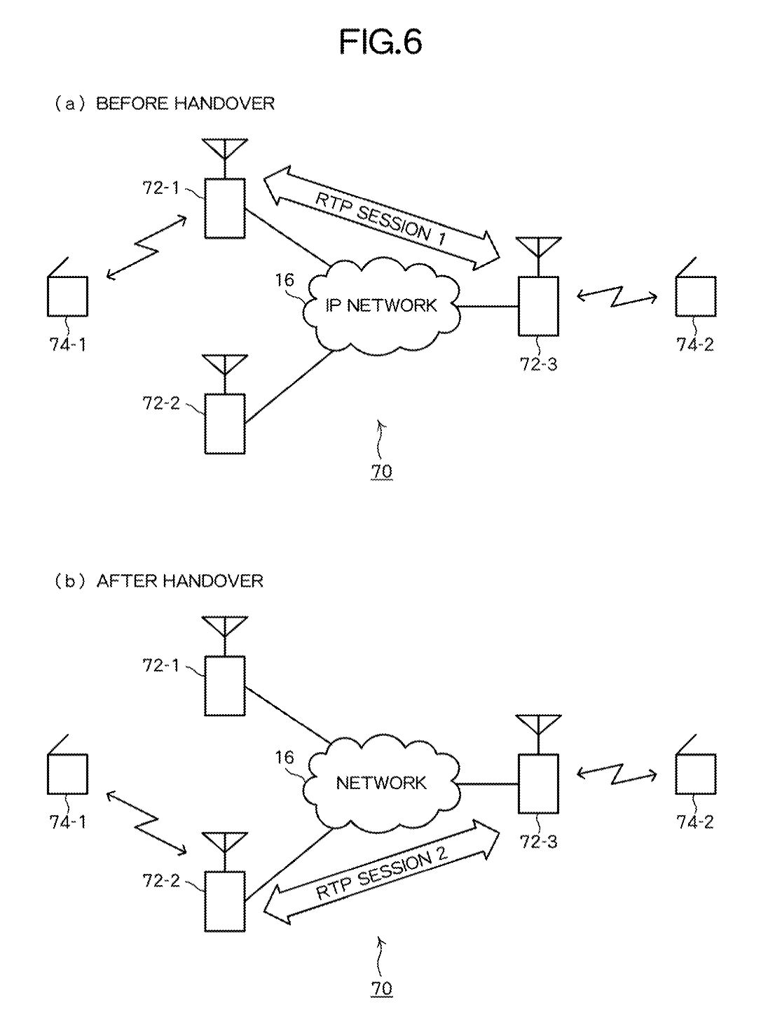

FIG. 5 is a flowchart illustrating an example of the switching processing of the RTP session which is executed by the handover destination base station 12-2 with handover of the mobile station 14-1 illustrated in FIG. 1. When the mobile station 14-1 starts handover from the base station 12-1 to the base station 12-2, the mobile station 14-1 newly starts a radio communication with the handover destination base station 12-2 in addition to the radio communication with the base station 12-1. Further, the handover source base station 12-1 switches the transmission destination of the RTP packet corresponding to the radio signal received from the mobile station 14-1 from the base station 12-3 to the handover destination base station 12-2.

In response to the above-mentioned operation, the base station 12-2 receives the radio signal transmitted from the mobile station 14-1 (S100), and stores the voice data corresponding to the received radio signal in the buffer (S102). Further, the base station 12-2 receives the RTP packet transmitted from the handover source base station 12-1 (S104).

Then, the base station 12-2 determines whether voice data identical with the voice data included in the RTP packet received in S104 is stored in the buffer, or not (S106). When the identical voice data is not stored in the buffer (N in S106), the base station 12-2 transfers the RTP packet received in S104 to the base station 12-3 as it is (S108). Further, the base station 12-2 stores the sequence number, the time stamp, and the SSRC identifier included in the header of the transferred RTP packet therein (S110).

On the other hand, when the voice data identical with the voice data included in the RTP packet received in S104 is stored in the buffer (Y in S106), the base station 12-2 carries over the sequence number, the time stamp, and the SSRC identifier stored in S110, and establishes a new RTP session with respect to the base station 12-3 (S112). That is, the base station 12-2 switches the RTP packet to be transmitted to the base station 12-3 from the RTP packet received from the handover source base station 12-1 to the RTP packet including the radio receive data from the mobile station 14-1 so as to maintain the continuity of the RTP packets before and after switching the RTP packet to be transmitted to the base station 12-3.

According to the mobile communication system 10 described above, the RTP session is established between the handover destination base station 12-2 and the base station 12-3 at a timing when the voice data transmitted from the handover source base station 12-1 to the base station 12-3 conforms to the voice data transmitted from the handover destination base station 12-1 to the base station 12-3. As a result, data transmitted from the mobile station 14-1 undergoing handover can be prevented from being lost.

It should be noted that the present invention is not limited to the above-mentioned embodiment, but various modifications can be made. For example, in the above description, the present invention is applied to the voice communication in the mobile communication system in which the base stations are connected to each other via the IP network. However, the present invention can be applied to the general communication in the mobile communication system in which the base stations are connected to each other via a network (including radio network) other than the IP network. Further, not only the RTP but also a UDP and other protocols may be applied to data transmission between the base stations.

1. A mobile communication system including a plurality of base station devices connected to each other via a network, in which a first mobile station device performs a handover from a first base station device to a second base station device,
wherein the first base station device comprises:
first data transmitting means for transmitting data corresponding to a radio signal received from the first mobile station device to another base station device that performs a radio communication with a second mobile station device which makes a call connection with the first mobile station device; and
data transmission destination switching means for switching a transmission destination of the data transmitted by the first data transmitting means from the another base station device to the second base station device with a handover start of the first mobile station device, and
wherein the second base station device comprises:
data receiving means for receiving the data transmitted by the first data transmitting means;
second data transmitting means for transferring the data received by the data receiving means to the another base station device;
identity determining means for determining identity of information included in the data received by the data receiving means and information included in a radio signal received from the first mobile station device; and
transmit data switching means for switching the data transmitted by the second data transmitting means from the data received by the data receiving means to data corresponding to the radio signal received from the first mobile station device at a timing when the identity of information is confirmed by the identity determining means.

2. The mobile communication system according to claim 1,
wherein data transmitted and received between the base station devices is a packet based on a connectionless transport protocol, and
wherein the transmit data switching means carries over at least a part of header information of a packet transmitted before the switching to a packet transmitted after the switching so as to maintain continuity of the packets transmitted by the second data transmitting means before and after the switching of the transmit data.

3. The mobile communication system according to claim 2,
wherein the connectionless transport protocol is an RTP protocol, and
wherein the transmit data switching means carries over a sequence number, a time stamp, and a synchronization source identifier included in a header of an RTP packet transmitted before the switching to an RTP packet transmitted after the switching so as to maintain continuity of the packets transmitted by the second data transmitting means before and after the switching of the transmit data.

4. A base station device that is connected to another base station device via a network, and with a start of handover made by a first mobile station device that performs a radio communication with the another base station device, starts a radio communication with the first mobile station device, the base station device comprising:
data receiving means for receiving data corresponding to a radio signal transmitted from the first mobile station device from the another base station device with the start of the handover;
data transmitting means for transferring the data received by the data receiving means to yet another base station device that performs a radio communication with a second mobile station device which makes a call connection with the first mobile station device;
identity determining means for determining identity of information included in the data received by the data receiving means and information included in a radio signal received from the first mobile station device; and
transmit data switching means for switching the data transmitted by the data transmitting means from the data received by the data receiving means to the data corresponding to the radio signal received from the first mobile station device at a timing when the identity of information is confirmed by the identity determining means.

5. A handover method for performing a handover from a first base station device to a second base station device by a first mobile station device in a mobile communication system including a plurality of base station devices connected to each other via a network, the handover method comprising:
a data transmission destination switching step of switching, by the first base station device, with a start of the handover made by the first mobile station device, a transmission destination of data corresponding to a radio signal received from the first mobile station device from another base station device that performs a radio communication with a second mobile station device which makes a call connection with the first mobile station device to the second base station device;
a data receiving step of receiving, by the second base station device, the data transmitted from the first base station device after the data transmission destination switching step;
a data transmitting step of transferring, by the second base station device, the data received in the data receiving step to the another base station device;
an identity determining step of determining, by the second base station device, identity of information included in the data received in the data receiving step and information included in a radio signal received from the first mobile station device; and
a step of switching, by the second base station device, the data transmitted in the data transmitting step from the data received in the data receiving step to the data corresponding to the radio signal received from the first mobile station device at a timing when the identity of information is confirmed in the identity determining means step.
